(19) United States
(12) Patent Application Publication
(10) Pub. No.: US 2023/0281804 A1
(43) Pub. Date: Sep. 7, 2023

(54) LANDMARK DETECTION IN MEDICAL IMAGES

(71) Applicant: KONINKLIJKE PHILIPS N.V., EINDHOVEN (NL)

(72) Inventors: HRISHIKESH NARAYANRAO DESHPANDE, HAMBURG (DE); THOMAS BUELOW, GROSSHANSDORF (DE); AXEL SAALBACH, HAMBURG (DE); TIM PHILIPP HARDER, AHRENSBURG (DE); STEWART MATTHEW YOUNG, HAMBURG (DE)

(21) Appl. No.: 18/017,949

(22) PCT Filed: Jul. 26, 2021
(86) PCT No.: PCT/EP2021/070768

§ 371 Date: Jan. 25, 2023

(30) Foreign Application Priority Data
Jul. 31, 2020 (EP) 20188914.4

(51) Int. Cl. G06T 7/00; G06V 10/762

(52) U.S. Cl. CPC G06T 7/0012; G06V 10/762; G06V 2201/07; G06T 2207/10081; G06T 2207/30008

(57) ABSTRACT

A mechanism for identifying a position of one or more anatomical landmarks in a medical image. The medical image is processed with a machine-learning algorithm to generate, for each pixel/voxel of the medical image, an indicator that indicates whether or not the pixel represents part of an anatomical landmark. The indicators are then processed in turn to predict a presence and/or position of the one or more anatomical landmarks.

### FIELD OF THE INVENTION

The present invention relates to a system and a method for anatomical landmark detection in medical images such as computed tomography (CT) images.

### BACKGROUND OF THE INVENTION

Medical imaging, such as CT imaging, is an increasingly important tool in correct analysis and assessment of a subject/patient.

Proper patient positioning is one of the most important considerations in medical images, particularly CT imaging, to ensure a high-quality scan. In CT imaging of the head (“head CT”), quality relates to the diagnostic aspect of the scan, e.g. diagnostic usefulness, as well as the dose exposure to the patient, which is preferably minimized or reduced.

Official standards for medical imaging techniques, such as head CT, provide guidelines for appropriate medical scanning, e.g. to generate clinically useful and repeatable medical images. Failure to adhere to the guidelines reduces a quality of images produced by the scanning procedure and can lead to unnecessary radiation exposure to at-risk organs or anatomical features, such as the eye lenses. Similarly, compliance with the guidelines produces an image of high quality, as the guidelines will typically ensure that images contain diagnostically sensitive or useful structures

These guidelines are usually defined with regard to a set of anatomical landmarks. For instance, one set of guidelines for head CT, published by the American Association of Physicists in Medicine, defines a recommended scan angle with respect to a set of anatomical landmarks: the opisthion of the occipital bone (oo), and the points each on the supra-orbital ridge of the left (le) and the right eye (re). FIG. 1 illustrates the position of these landmarks with respect to the skull and corresponding CT images of the subject.

In order to verify the scan angle and the scan extent, and thereby to provide a quality control system for medical images, an automatic detection of landmarks, such as these three landmarks, is desirable. Landmarks also prove useful in control of aby subsequent medical imaging scans, e.g. to define or control parameters of the subsequent medical imaging scan(s).

One existing approach is to apply an atlas registration technique to map a medical image (e.g. 3D image or volume) to a probabilistic anatomical atlas, in order to label landmarks.

### SUMMARY OF THE INVENTION

The invention is defined by the claims.

According to examples in accordance with an aspect of the invention, there is provided a computer-implemented method of predicting a presence and/or position of a predetermined anatomical landmark with respect to a medical image of a subject.

The computer-implemented method comprises obtaining the medical image of the subject, the medical image containing a plurality of pixels or voxels; processing the computer tomography image using a machine-learning algorithm to generate, for each pixel or voxel of the image, an indicator representing a likelihood that the corresponding pixel or voxel represents part of a predetermined anatomical landmark of the subject; and processing the generated indicators to predict the presence and/or position of the predetermined anatomical landmark with respect to the medical image.

Thus, the present disclosure proposes to process a medical image using a machine-learning method to generate a (segmentation) map that indicates (for each pixel/voxel of the medical image) a likelihood that the said pixel/voxel represents part of a predetermined anatomical landmark, e.g. a point on a supra-orbital ridge of the left/right eye or the opisthion of the occipital bone. Other suitable landmarks will be apparent to the skilled person, e.g. according to different guidelines for assessing or guiding a medical imaging workflow and/or according to a part of the subject being imaged.

The map is then further processed to predict a presence and/or position of the predetermined anatomical landmark with respect to the medical image. Thus, an anatomical landmark is not directly mapped to the medical image, but rather an intermediate step of generating the probability map (i.e. the indicators for each pixel/voxel) is performed.

In this way, identification of the position of the predetermined anatomical landmark is effectively reduced to a segmentation problem or task, facilitating use of machine-learning algorithms, e.g. deep learning architectures such as U-net or F-net. These machine-learning algorithms could be trained or adapted to specific guidelines requirements for landmarks (e.g. region, site, professional body or clinician specific preferences or recommendations). An adaptable and accurate method of predicting the position of predetermined anatomical landmarks is therefore provided.

The medical image may be a 2D image, a 3D image or a higher-dimensionality image (e.g. where a fourth dimension may represent time). The term pixel/voxel is considered to refer to the smallest addressable element of the image (regardless of dimensionality) representing a particular point or area of space. Of course, a pixel/voxel may be conceptually divisible into “sub-pixels” or “sub-voxels” (e.g. each representing a different color contributing to the pixel/voxel).

The medical image may be a survey image, e.g. a low-resolution medical image generated in advance of performing a diagnostic medical scan upon the subject. Alternative labels for the survey image include a “localizer image” or “surview”. Detecting of landmarks in a survey image facilitates control over the performance of a later medical scan, e.g. to minimize exposure of anatomical landmarks representing radiation-sensitive areas or imaging-sensitive areas of the subject to radiation (or other imaging system output) or to control a medical scan to capture a desired or preferred volume/slice for imaging.

Of course, in some embodiments, the medical image may be a full diagnostic medical image.

The skilled person will appreciate that multiple predetermined anatomical landmarks could be identified in single image, e.g. by making use of multiple machine-learning algorithms (each designed to generate, for each pixel, a single indicator for different anatomical landmarks) or a single machine-learning algorithm (designed to generate, for each pixel, multiple indicators for each of a plurality of anatomical landmarks). The steps of processing the medical image and the generated indicators may be appropriately configured for generating multiple (types of) indicator (e.g. for different anatomical landmarks) and for predicting the presence and/or position of different anatomical landmarks.

The predetermined anatomical landmark is preferably an anatomical landmark that represents a part of the subject that is (negatively) sensitive to radiation and/or imaging, and in particular is more sensitive to radiation/imaging exposure than other elements of the subject. This facilitates control of later medical imaging of the subject to avoid radiation- or imaging-sensitive areas of the subject.

The step of processing the generated indicators may comprise: identifying, as high likelihood pixels/voxels, any pixels/voxels having a corresponding indicator that indicates a likelihood that the corresponding pixel or voxel of the image represents part of a predetermined anatomical landmark exceeds a predetermined threshold; identifying the largest cluster of high likelihood pixels/voxels; and predicting the position of the predetermined anatomical landmark to lie within the identified largest cluster of high likelihood pixels/voxels.

It is recognized that the largest cluster of pixels that are associated with a high likelihood that they represent part of the anatomical landmark is most likely to contain the true position of the anatomical landmark. Thus, an accuracy of identifying a location of the predetermined anatomical landmark in the medical image is increased.

The step of predicting the position of the predetermined anatomical landmark may comprise identifying a centroid of the identified largest cluster of high likelihood pixels/voxels as the position of the predetermined anatomical landmark.

The likelihood that a pixel represents the position of the predetermined anatomical landmark increases the closer that pixel is to the center of the largest cluster of high likelihood pixels/voxels. This embodiment effectively assumes a landmark is represented by a shape (e.g. circle or sphere) of small dimensions (e.g. small radius), where a center of the shape represents the true position of the landmark, with the perimeter of the shape indicating an error margin of the true position.

In some examples, the step of identifying the largest cluster of high likelihood pixels/voxels comprises: performing a clustering algorithm on the high likelihood pixels/voxels to identify one or more clusters of high likelihood pixels/voxels; and identifying the largest of the one or more clusters of high likelihood pixels/voxels.

Optionally, each cluster of high likelihood pixels/voxels consists of pixels that are adjacent to at least one other pixel in the cluster of high likelihood pixels/voxels.

In other words, a cluster may comprise connected high likelihood pixels/voxels of the medical image. Thus, identifying the largest cluster of pixels may effectively comprise identifying the largest connected set of high likelihood pixels/voxels in the medical image.

In some examples, each indicator is a numeric indicator representing a probability that the corresponding pixel represents part of the predetermined anatomical landmark. In at least one example, each indicator is a binary indicator representing a prediction or whether or not the corresponding pixel represents part of the predetermined anatomical landmark.

Thus, an indicator may be a binary or numeric indicator. Either form of indicator is able to represent a prediction of whether or not a corresponding pixel represents part of the predetermined anatomical landmark. In particular, a binary indicator may represent whether or not a likelihood that the corresponding pixel represents part of the predetermined anatomical landmark exceeds some predetermined threshold. Of course, in some examples, the indicator may be a categorical indicator.

In some examples, the predetermined anatomical landmark is an anatomical landmark defined by a predetermined set of guidelines for performing medical scanning on the subject. Different guidelines for medical scanning may define different anatomical landmarks for assessing a success or quality of a generated medical image. This embodiment facilitates more adaptable and flexible approaches for identifying a presence and/or position of an anatomical landmark in a medical image, e.g. to adapt to different environments, clinicians, professional bodies and so on.

The method may further comprise a step of controlling a user interface to provide a user-perceptible output responsive to the predicted presence and/or position of the anatomical landmark with respect to the computer tomography image.

There is also proposed a computer-implemented method of determining a quality of medical image. The computer-implemented method comprises: predicting a presence and/or position of a predetermined anatomical landmark with respect to the medical image by performing the computer-implemented method previously described; and determining a quality of the medical image based on the predicted presence and/or position of the predetermined anatomical landmark with respect to the anatomical image.

The step of determining a quality of the medical image may comprise determining a measure of how closely the predicted presence and/or position of the predetermined anatomical landmark matches a desired presence and/or position. The desired presence and/or position may be defined, for instance, in a set of predetermined guidelines for performing the medical scan.

There is also proposed a computer program product comprising computer program code means which, when executed on a computing device having a processing system, cause the processing system to perform all of the steps of any herein described method. The computer program product may be formed as a non-transitory computer storage medium.

There is also proposed a processing system configured to predict a presence and/or position of a predetermined anatomical landmark with respect to a medical image of a subject.

The processing system is configured to: obtain, at an input interface, the medical image of the subject, the medical image containing a plurality of pixels or voxels; process the computer tomography image using a machine-learning algorithm to generate, for each pixel or voxel of the image, an indicator representing a likelihood that the corresponding pixel or voxel represents part of a predetermined anatomical landmark of the subject; and process the generated indicators to predict the presence and/or position of the predetermined anatomical landmark with respect to the medical image.

The processing system may be configured to process the generated indicators by: identifying, as high likelihood pixels/voxels, any pixels having a corresponding indicator that indicates a likelihood that the corresponding pixel or voxel of the image represents part of a predetermined anatomical landmark exceeds a predetermined threshold; identifying the largest cluster of high likelihood pixels/voxels; and predicting the position of the predetermined anatomical landmark to lie within the identified largest cluster of high likelihood pixels/voxels.

There is also proposed an imaging system comprising: the processing system previously described; and a medical imaging scanner configured to generate the medical image of the subject by performing a medical imaging scan of the subject.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates the position of example anatomical landmarks;

FIG. 2 illustrates a system including an imaging system;

FIG. 3 illustrates a method;

FIG. 4 is an example CT image demonstrating an embodiment;

FIG. 5 illustrates a method for use in an embodiment;

FIG. 6 illustrates a method according to an embodiment;

FIG. 7 illustrates a processing system according to an embodiment.

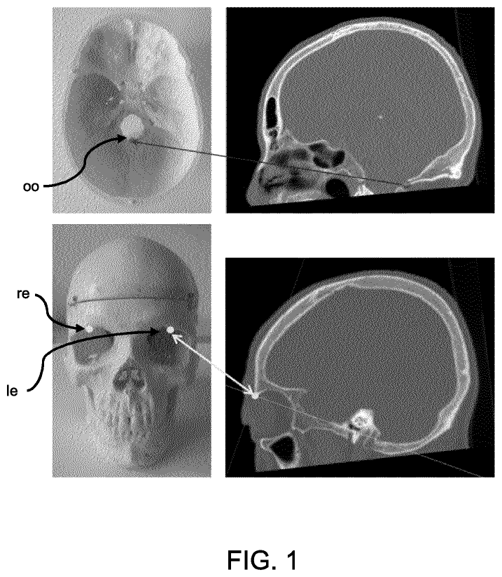

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for identifying a position of one or more anatomical landmarks in a medical image. The medical image is processed with a machine-learning algorithm to generate, for each pixel/voxel of the medical image, an indicator that indicates whether or not the pixel represents part of an anatomical landmark. The indicators are then processed in turn to predict a presence and/or position of the one or more anatomical landmarks.

The present invention therefore recasts a problem of landmark detection as a segmentation task. This facilitates end-to-end processing of the medical image, and provides an accurate and fast approach for performing landmark detection.

The present invention relates to the field of medical imaging, and in particular to the processing of medical images to identify one or more anatomical landmarks. Embodiments of the invention are particularly advantageous when employed to identify anatomical landmarks in a CT image, e.g. a CT image of a head of a subject. This is because the landmarks may be used to define a control of later CT imaging of the subject, and in particular to reduce or minimize exposure of the subject to radiation.

However, the skilled person will recognize that the approach for identifying landmarks in medical images can extend to other imaging modalities, such as X-ray images, ultrasound images, positron emission tomography images and/or magnetic resonance images.

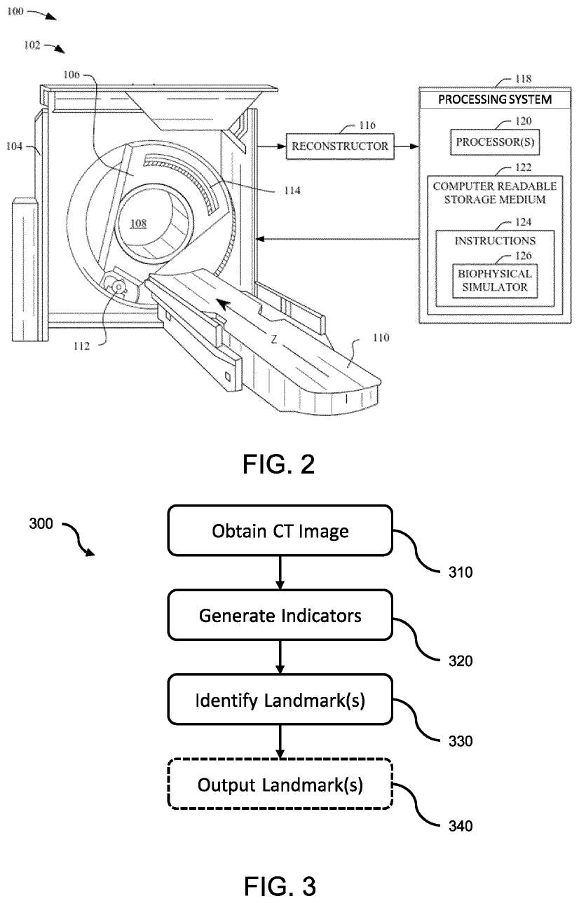

FIG. 2 schematically illustrates a system 100 including an imaging system 102 such as a CT scanner. The imaging system 102 includes a generally stationary gantry 104 and a rotating gantry 106, which is rotatably supported by the stationary gantry 104 and rotates around an examination region 108 about a z-axis. A subject support 110, such as a couch, supports an object or subject in the examination region 108.

A radiation source 112, such as an x-ray tube, is rotatably supported by the rotating gantry 106, rotates with the rotating gantry 106, and emits radiation that traverses the examination region 108.

A radiation sensitive detector array 114 subtends an angular arc opposite the radiation source 112 across the examination region 108. The radiation sensitive detector array 114 detects radiation traversing the examination region 108 and generates an electrical signal(s) (projection data) indicative thereof.

The detector array 114 can include single layer detectors, direct conversion photon counting detectors, and/or multi-layer detectors. The direct conversion photon counting detectors may include a conversion material such as CdTe, CdZnTe, Si, Ge, GaAs, or other direct conversion material. An example of multi-layer detector includes a double decker detector such as the double decker detector described in U.S. Pat. No. 7,968,853 B2, filed Apr. 10, 2006, and entitled “Double Decker Detector for Spectral CT,”.

A reconstructor 116 of the imaging system 102 receives projection data from the detector array 114 and reconstructs one or more CT images from the projection data. The reconstructed CT images may comprise one or more 2D or 3D images. Mechanisms for reconstructing one or more CT images from projection data are well-established in the art.

A processing system 118 is configured to process CT images generated by the imaging system 102. In particular, the processing system 118 may process CT images by performing a process described in the present disclosure, i.e. to predict a presence and/or position of a predetermined anatomical landmark (or a plurality of predetermined anatomical landmarks) with respect to one or more CT images.

The processing system 118 may include a processor 120 (e.g., a microprocessor, a controller, a central processing unit, etc.) and a computer readable storage medium 122, which excludes non-transitory medium, and includes transitory medium such as a physical memory device, etc.

The computer readable storage medium 122 may include instructions 124 for predicting a presence and/or position of a predetermined anatomical landmark with respect to a CT image. The processor 120 is configured to execute the instructions 124. The processor 120 may additionally be configured to execute one or more computer readable instructions carried by a carrier wave, a signal and/or other transitory medium.

However, instead of a processor 120 executing instructions to perform a herein described method, the processor may instead comprise fixed-function circuitry (e.g. appropriately programmed FPGAs or the like) to carry out the described methods.

In some examples, the processing system may also serve as an operator console. The processing system 118 includes a human readable output device such as a monitor and an input device such as a keyboard, mouse, etc. Software resident on the processing system 118 allows the operator to interact with and/or operate the scanner 102 via a graphical user interface (GUI) or otherwise. The processing system 118 further includes a processor 120 (e.g., a microprocessor, a controller, a central processing unit, etc.) and a computer readable storage medium 122, which excludes non-transitory medium, and includes transitory medium such as a physical memory device, etc.

In a variation, a separate processing system (not shown) may serve as an operator console, and comprise the relevant operator console elements previously described.

It has previously been explained how approaches can be adapted for use with other forms or modalities of medical image, such as X-ray images, ultrasound images, positron emission tomography images and/or magnetic resonance images. The system 100 of FIG. 2 may be adapted accordingly, e.g. to provide a different form of medical scanner than a CT scanner, such as an ultrasound scanner or an MM scanner.

FIG. 3 illustrates a (computer-implemented) method 300 for predicting a presence and/or position of a predetermined anatomical landmark with respect to a medical image. A medical image may be a CT image, X-ray image, ultrasound image, positron emission tomography image or magnetic resonance image.

The method 300 may, for instance, be carried out by a processing system configured to receive one or more medical images from a medical imaging system and/or a memory. One example of such a processing system has been described with reference to FIG. 2.

The method 300 comprises a step 310 of obtaining a medical image of the subject. The medical image may be obtained directly from a medical imaging system or from a memory storing a medical image. The medical image may be a 2D or 3D (or higher dimension) image. Accordingly, the medical image comprises a plurality of pixels or voxels. In the context of the present disclosure a voxel is considered to represent a point in 3D or higher dimensionality space, just as a pixel represents a point in 2D space.

The method 300 also comprises a step 320 of processing the computer tomography image using a machine-learning algorithm to generate, for each pixel or voxel of the image, an indicator representing a likelihood that the corresponding pixel or voxel represents part of a predetermined anatomical landmark of the subject. Step 320 effectively comprises performing a segmentation of the medical image to identify areas that are likely to contain the anatomical landmark. A machine-learning algorithm, such as a neural network, can be trained or configured to perform a segmentation task.

The indicator may be a binary indicator (e.g. indicating whether or not a likelihood that said pixel/voxel represents an anatomical landmark exceeds some predetermined threshold) or a numeric indicator (e.g. a probability, e.g. on a scale of 0-1, 0-10, 0-100, 1-10 or 1-110, that said pixel/voxel represents (part of) an anatomical landmark.

In some examples, the machine-learning algorithm produces a probability for each pixel or voxel. The probability may represents a probability that said pixel/voxel represents (part of) an anatomical landmark. The probability may itself act as an indicator, or may be further processed (e.g. using a thresholding function) to produce a binary indicator. For instance, each probability may be subject to a threshold function, where values at or above some predetermined value are assigned a first binary value and values below the predetermined value are assigned a second binary value, to thereby produce a binary indicator for each probability.

The method 300 comprises a step 330 of processing the generated indicators to predict the presence and/or position of the predetermined anatomical landmark with respect to the medical image.

Step 330 may comprise, for example, identifying a pixel or voxel that meets a set of one of more predetermined requirements, e.g. to thereby identify the presence and/or position of the anatomical landmark (represented by a position of a pixel/voxel in the medical image).

For instance, if one or more pixels or voxels meet the set of one or more predetermined requirements, then this indicates the presence of the predetermined anatomical landmark. The position of the pixel/voxel (within the medical image) also indicates the relative position of the predetermined anatomical landmark.

One example of a set of predetermined requirements may be that the identified pixel/voxel: i) has an indicator that indicates a likelihood that the pixel represents part of the anatomical landmark exceeds a first predetermined threshold; and ii) is surrounded by pixels, each of which has an indicator that indicates a likelihood that said pixel represents part of the anatomical landmark exceeds a second predetermined threshold. The first and second predetermined thresholds may be identical and/or different.

Another example of a set of predetermined requirements may be that the identified pixel/voxel forms part of a group or cluster of (connected) pixels, each of which has an indicator that indicates a likelihood that said pixel represents part of the anatomical landmark exceeds a predetermined threshold.

Another approach for processing generated indicators to predict the presence and/or position of the predetermined anatomical landmark will be described later in this document.

Whilst the use of machine-learning algorithms to perform segmentation is well-established, segmentation has not previously been used to identify landmarks (as a landmark is an extremely small position or location within a larger image, and segmentation techniques are unable to accurately identify the position of such a small position/location). However, the present disclosure recognizes that by using a segmentation technique to produce a likelihood map, then areas of high likelihood indicate a particular area that surrounds the anatomical landmark (e.g. a circle or (hyper-)sphere). This means that a position of the anatomical landmark can be estimated or predicted by identifying and processing areas of high likelihood.

Thus, the present invention differs from established landmark identification processes in that a segmentation technique can be used, thereby rephrasing the problem of landmark detection as a segmentation task.

The method 300 may further comprise a step 340 of outputting the predicted presence and/or position of the anatomical landmark. This may comprise outputting the predicted presence and/or position of the anatomical landmark, e.g. in the form of output data, to a further processor for further processing.

In one example, step 340 comprises controlling a user interface to provide a user-perceptible output responsive to the predicted presence and/or position of the anatomical landmark with respect to the computer tomography image. This may, for example, be in the form of a visual representation of the position of the anatomical landmark that overlays a visual representation of the medical image at the appropriate relative position. As another example, a visual representation of whether or not the anatomical landmark is predicted to be present may be provided, e.g. in the form of an area or light that changes color/brightness responsive to the predicted presence or absence of the anatomical landmark.

Step 320 makes use of a machine-learning algorithm to generate an indicator, for each of a plurality of pixels/voxels, of a likelihood that said pixel/voxel represents an anatomical landmark. The indicator may be a binary, categorical or numeric indicator.

A machine-learning algorithm is any self-training algorithm that processes input data in order to produce or predict output data. Here, the input data comprises medical images (formed of pixels or voxels) and the output data comprises an indicator, for each pixel or voxel, of the likelihood that said pixel/voxel/indicator represents an anatomical landmark.

Suitable machine-learning algorithms for being employed in the present invention will be apparent to the skilled person. Examples of suitable machine-learning algorithms include decision tree algorithms and artificial neural networks. Suitable artificial neural networks for use with the present invention include, for instance, U-Net or F-net architectures. Other machine-learning algorithms such as logistic regression, support vector machines or Naïve Bayesian models are suitable alternatives.

The structure of an artificial neural network (or, simply, neural network) is inspired by the human brain. Neural networks are comprised of layers, each layer comprising a plurality of neurons. Each neuron comprises a mathematical operation. In particular, each neuron may comprise a different weighted combination of a single type of transformation (e.g. the same type of transformation, sigmoid etc. but with different weightings). In the process of processing input data, the mathematical operation of each neuron is performed on the input data to produce a numerical output, and the outputs of each layer in the neural network are fed into the next layer sequentially. The final layer provides the output.

Methods of training a machine-learning algorithm are well known. Typically, such methods comprise obtaining a training dataset, comprising training input data entries and corresponding training output data entries (“ground truth”). An initialized machine-learning algorithm is applied to each input data entry to generate predicted output data entries. An error between the predicted output data entries and corresponding training output data entries is used to modify the machine-learning algorithm. This process can be repeated until the error converges, and the predicted output data entries are sufficiently similar (e.g. ±1%) to the training output data entries.

For example, where the machine-learning algorithm is formed from a neural network, (weightings of) the mathematical operation of each neuron may be modified until the error converges. Known methods of modifying a neural network include gradient descent, backpropagation algorithms and so on.

The training input data entries correspond to example medical images. The training output data entries correspond to (true) positions (and/or presence) of an anatomical landmark in the medical images. The (true) positions of the anatomical landmark(s) are provided by suitably trained clinicians, e.g. annotating example medical images.

The proposed approach also offers an advantage of being trainable in end-to-end fashion, as compared to the traditional image processing methods such as atlas based methods, which could require multiple steps to detect the landmarks.

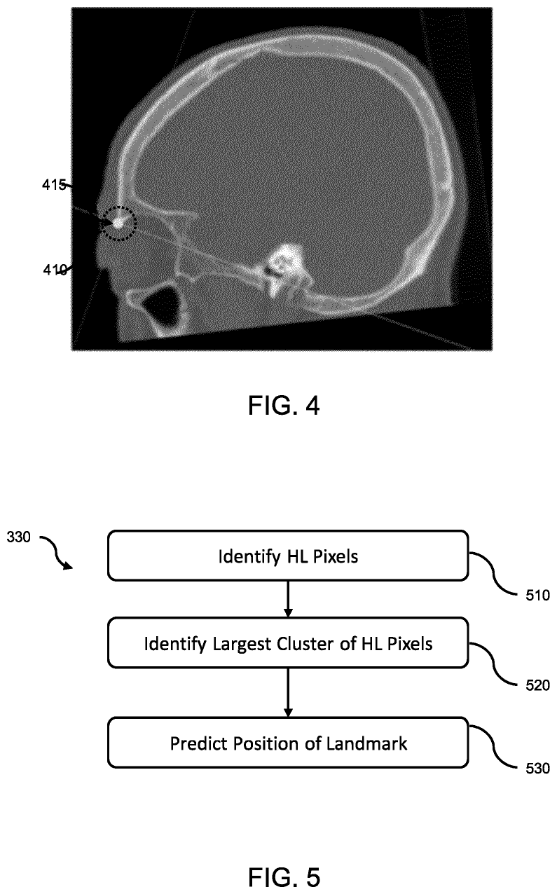

FIG. 4 illustrates a medical image (here: a CT image) on which a method according to an embodiment, such as that described with reference to FIG. 3, has been performed. The medical image has been processed to identify an anatomical landmark 410, which is here a point each the supra-orbital ridge of one of the eyes.

The anatomical landmark has been identified by processing the medical image to identify an area 415 that has high likelihood of containing the anatomical landmark. In particular, this area may represent a cluster of pixels/voxels associated with indicators that indicate that a probability that the pixel contains part of an anatomical landmark is above some predetermined threshold.

The indicators are then processed to identify or predict the presence and/or position of the anatomical landmark. This may be performed, for instance, by identifying the area 415 and selecting a center or centroid of this area 415 as the position of the anatomical landmark 410, to thereby select or identify a position of the anatomical landmark.

This example illustration demonstrates how an appropriately trained machine-learning method will identify (by way of the content of the indicators) an area in the vicinity of the true position of the anatomical landmark, e.g. a circle or sphere that surrounds the true position of the anatomical landmark. Thus, the position of the anatomical landmark can be identified by processing the indicators.

FIG. 5 illustrates a process 330 for processing generated indicators in order to predict the presence and/or position of the anatomical landmark. Thus, FIG. 5 illustrates an embodiment of step 330 described with reference to FIG. 3.

The process 330 comprises a step 510 of identifying high likelihood pixels/voxels in the medical image. A high likelihood pixel/voxel is any pixel/voxel that has having a corresponding indicator that indicates a likelihood that the corresponding pixel or voxel of the image represents part of a predetermined anatomical landmark exceeds a predetermined threshold.

Where the indicator is a binary indicator, this may comprise identifying any pixels having a binary indicator having a value that indicates the predicted likelihood that the pixel/value exceeds some predetermined threshold, e.g. whether the binary indicator contains a first binary value.

Where the indicator is a numeric indicator, this may comprise identifying whether the numeric indicator exceeds the predetermined threshold.

The process 330 then performs a step 520 of identifying the largest cluster of high likelihood pixels/voxels. It is recognized that the largest cluster of high likelihood pixels is the most likely to contain the true position of the anatomical landmark.

Step 510 may comprise performing a clustering algorithm on the high likelihood pixels/voxels to identify one or more clusters of high likelihood pixels/voxels; and identifying the largest of the one or more clusters of high likelihood pixels/voxels. Any suitable clustering algorithm may be used, such as a hierarchical clustering approach, a k-means clustering approach or density based clustering approach.

In one example, a clustering approach is selected so that each cluster of high likelihood pixels/voxels consists of pixels/voxels that are adjacent to at least one other pixel/voxel in the cluster of high likelihood pixels/voxels. Thus, the clustering algorithm may comprise identifying clusters or groups of connected pixels. This embodiment recognizes that a true position of the anatomical landmark is more likely to result in adjacent pixels/voxels indicating that there is a high likelihood that said pixel/voxel contains the anatomical landmark. Noise in the medical image and/or indicators will not significantly impact the efficacy of this approach, as it remains likely that high likelihood pixels/voxels in the vicinity of the true position of the anatomical landmark will neighbor or abut at least one other high likelihood pixel.

The method then performs a step 530 of predicting the position of the landmark based on the largest cluster of high likelihood pixels, e.g. so that the predicted position lies within the identified largest cluster of high likelihood pixels/voxels.

Step 530 may comprise, for instance, by identifying a centroid of the identified largest cluster of high likelihood pixels/voxels as the position of the predetermined anatomical landmark. The likelihood that a pixel represents the position of the predetermined anatomical landmark increases the closer that pixel is to the center of the largest cluster of high likelihood pixels/voxels. This embodiment effectively assumes a landmark is represented by a shape (e.g. circle or sphere) of small dimensions (e.g. small radius), where a center of the shape represents the true position of the landmark, with the perimeter of the shape indicating an error margin of the true position.

Other approaches for performing step 530 may be employed.

As one example, if the indicators are numeric indicators representing a probability, step 530 may comprise identifying the position of the pixel/voxel associated the indicator having the highest probability in the set of high likelihood pixels/voxels as the position of the anatomical landmark.

As another example, step 530 may comprise identifying the position of the center pixel/voxel of a block of pixels/voxels of a predetermined size (e.g. 3×3, 5×5, 7×7, 3×5, 3×7, 5×7 for a block of pixels or 3×3×3, 5×5×5, 7×7×7 or a predetermined spherical shape for a block of voxels and so on) that meet some predetermined criteria as the position of the anatomical landmark. The predetermined criteria may here be the block of pixels/voxels having the highest number of pixels/voxels associated with indicators that a likelihood that the corresponding pixel or voxel represents part of a predetermined anatomical landmark of the subject exceeds some predetermined threshold. As another example, if the indicators are numeric indicators, the predetermined criteria may be the block of pixels/voxels having the highest combined value of its associated numeric indicators.

Previous embodiments have described how to identify a (position of an) anatomical landmark in a medical image through appropriate processing steps. The skilled person will appreciate how multiple anatomical landmarks could be identified in a single medical image through appropriate adaptation of the proposed processing steps.

For instance, a single machine-learning method may be configured to generate a set of indicators for each pixel/voxel, each indicator representing a likelihood that the corresponding pixel or voxel represents part of a different predetermined anatomical landmark of the subject. The sets of indicators can then be processed appropriately to identify the position of the anatomical landmarks.

As another example, multiple machine-learning methods may process the medical image to produce a set of indicators for each pixel/voxel, each indicator representing a likelihood that the corresponding pixel or voxel represents part of a different predetermined anatomical landmark of the subject. The sets of indicators can then be processed appropriately to identify the position of the anatomical landmarks.

Thus, previously described methods may be configured to predict the presence and/or position of one or more anatomical landmarks, e.g. a single anatomical landmark or a plurality of anatomical landmarks. Preferably, the one or more anatomical landmarks comprises two or more anatomical landmarks.

If the presence and/or positions of multiple anatomical landmarks are detected, then a step of controlling a user interface to provide a visual representation of each anatomical landmark may be performed.

The precise anatomical landmark(s) detected may be dependent upon user preference, e.g. depending upon medical guidelines that a user wishes to assess or control a medical imaging process.

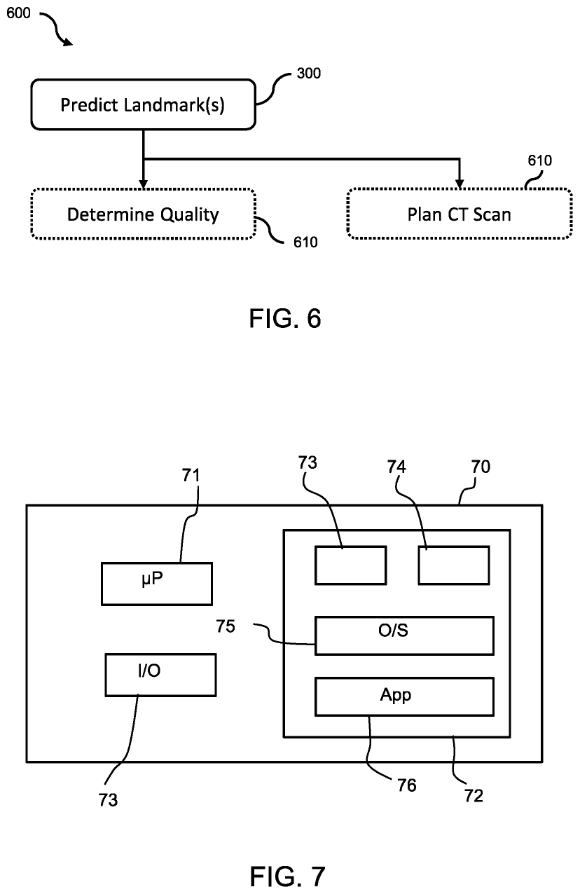

FIG. 6 illustrates a method 600 according to an embodiment of the invention. The method 600 demonstrates particularly advantageous embodiments that make use of the identified anatomical landmark(s).

The method 600 comprises a process 300 of predicting a presence and/or position of a predetermined anatomical landmark or landmarks with respect to a medical image of the subject. Embodiments of process 300 have been previously described, e.g. with reference to FIGS. 3 to 5.

The method 600 may comprise a step 610 of determining a quality of the medical image based on the predicted presence and/or position of the predetermined anatomical landmark or landmarks with respect to the anatomical image.

The step 610 of determining a quality of the medical image comprises determining a measure of how closely the predicted presence and/or position of the predetermined anatomical landmark(s) matches a desired presence and/or position. This may, for instance, comprise determining a distance between the predicted position and the desired position (e.g. according to some guidelines). The desired presence and/or position may be defined, for instance, in a set of predetermined guidelines for performing the medical scan.

Information on the quality of the medical image may be used, for instance, to facilitate correction actions such as training. Information on the quality of the medical image also provides valuable clinical information for a clinician in assessing the condition of the subject, e.g. as they will be provided with information about how clinically useful or accurate the medical image may be for the purposes of assessment.

The method 600 may therefore comprise a step of controlling a user-perceptible output responsive to the determined quality of the medical image. For instance, if the predicted position of the anatomical landmark(s) are not within a predetermined distance of the desired position(s), a user-perceptible alert may be generated. This may help alert a clinician to potential issues with a medical scanning process.

The method 600 may otherwise or additionally comprise a step 620 of controlling a medical imaging scan based on the identified position of the anatomical landmark(s). This may comprise defining one or more scanning parameters for the medical scan, such as defining a volume of the subject to be scanned and/or scanning depth and/or radiation intensity and so on.

For instance, a position of a landmark (or landmarks) may be used to define a volume that is imaged during a subsequent medical imaging scan, e.g. to avoid irradiating the landmark and/or to purposively capture a volume including the landmark(s).

In some examples, where multiple anatomical landmarks are identified, the anatomical landmarks are used to define a plane and/or volume that is purposively imaged during a later medical imaging scanning operation or purposively avoided (e.g. radiation dosage minimized) during a later medical image scanning operation. This is possible because the relationship between an obtained medical image and the operation of a medical image scanner can be established in advance, and can be used to control a subsequent medical image scan.

By way of example, if the anatomical landmarks include the opisthion of the occipital bone (oo), and the points each on the supra-orbital ridge of the left (le) and the right eye (re), then the anatomical landmarks define a least desirable plane for imaging (as the plane would contain areas that are most sensitive to radiation, e.g. eye lenses).

As another example, a relationship between anatomical landmarks (e.g. a distance) may be used to define a radiation intensity. For instance, a greater distance between different anatomical landmarks may indicate a larger sized subject or part of the subject (e.g. compared to population mean), meaning that a greater radiation intensity is required to successfully image the subject (e.g. ensure full subject penetration). Controlling based on the relationship between anatomical landmarks may mean that a total amount of radiation can be reduced (e.g. as excess radiation to ensure a “safe zone” can be avoided).

International Patent Application having publication no. WO 2016/135120 A1 provides one example of controlling a subsequent medical image scan based on initial survey image data. The proposed use of anatomical landmarks to control or define areas to purposively avoid and/or capture during scanning can be used in conjunction with such approaches, e.g. to appropriately control a medical image scan.

U.S. Pat. No. 8,144,955 B2 describes another approach in which landmark data is used to define a computer planning geometry for a scan, and the anatomical landmarks generated by way of the present disclosure could be processed in a similar way.

International Patent Application having publication no. WO 02 091924 A1 describes yet another approach that uses landmarks to define scanning parameters of a medical image scan. The anatomical landmarks identified using the approach of the present disclosure could be employed to much the same effect.

Embodiments of the invention have described how a machine-learning method is used to generate indicators for each pixel/voxel of the medical image. As previously explained, the machine-learning method is trained using a training dataset.

It is appreciated that different clinical environments (e.g. different hospitals, different medical specialties, different organizational units, companies, corporations or trusts and so on), professional bodies, jurisdictions and/or users may have different preferences for defining the anatomical landmarks that they wish to identify in medical images, e.g. due to differing guidelines. In some embodiments, it is therefore preferable that a machine-learning method is trained for a specific use case scenario (e.g. a specific clinical environment or user). This can be performed by training the machine-learning method based on a training dataset for each different use case scenario, e.g. where the training output data entries are provided by suitably trained professionals.

If multiple versions of training output data entries for the landmark(s) in a same medical image are available from multiple experts or sources, training of a machine-learning method may use a combined or averaged positon for the anatomical landmark (from these different versions) as the training output data entries, to produce more robust results.

There often exists inter-observer variability between different users for any complex medical applications. Machine-learning methods trained using different versions of the training output data entries (e.g. representing different users) may be used to investigate a reliability of the different users. For instance, consider a scenario in which a first machine learning method (trained using training data provided by a first user) produces a first predicted position for an anatomical landmark and a second machine learning method (trained using training data provided by a second user) produces a second predicted position for the same anatomical landmark. A metric between these two predicted positions (e.g. Euclidian distance) could be used to assess the accuracy of one or more of the users in identifying the true position of the anatomical landmark (e.g. if the first user is an expert and the second user is a trainee/novice—this can be used to assess the accuracy of the trainee/novice).

By way of further example, FIG. 7 illustrates an example of a processing system 70 (or computer) within which one or more parts of an embodiment may be employed. The illustrated processing system 70 is one example of a processing system as first illustrated in FIG. 2.

Various operations discussed above may utilize the capabilities of the processing system 70. For example, one or more parts of a system for processing a medical image may be incorporated in any element, module, application, and/or component discussed herein. In this regard, it is to be understood that system functional blocks can run on a single processing system or may be distributed over several computers and locations (e.g. connected via internet).

The processing system 70 includes, but is not limited to, PCs, workstations, laptops, PDAs, palm devices, servers, storages, and the like. Generally, in terms of hardware architecture, the processing system 70 may include one or more processors 71, memory 72, and one or more I/O devices 77 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 71 is a hardware device for executing software that can be stored in the memory 72. The processor 71 can be virtually any custom made or commercially available processor, a central processing unit (CPU), a digital signal processor (DSP), or an auxiliary processor among several processors associated with the processing system 70, and the processor 71 may be a semiconductor based microprocessor (in the form of a microchip) or a microprocessor.

The memory 72 can include any one or combination of volatile memory elements (e.g., random access memory (RAM), such as dynamic random access memory (DRAM), static random access memory (SRAM), etc.) and non-volatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 72 may incorporate electronic, magnetic, optical, and/or other types of storage media. Note that the memory 72 can have a distributed architecture, where various components are situated remote from one another, but can be accessed by the processor 71.

The software in the memory 72 may include one or more separate programs, each of which comprises an ordered listing of executable instructions for implementing logical functions. The software in the memory 72 includes a suitable operating system (O/S) 75, compiler 74, source code 73, and one or more applications 76 in accordance with exemplary embodiments. As illustrated, the application 76 comprises numerous functional components for implementing the features and operations of the exemplary embodiments. The application 76 of the processing system 70 may represent various applications, computational units, logic, functional units, processes, operations, virtual entities, and/or modules in accordance with exemplary embodiments, but the application 76 is not meant to be a limitation.

The operating system 75 controls the execution of other processing system programs, and provides scheduling, input-output control, file and data management, memory management, and communication control and related services. It is contemplated by the inventors that the application 76 for implementing exemplary embodiments may be applicable on all commercially available operating systems.

Application 76 may be a source program, executable program (object code), script, or any other entity comprising a set of instructions to be performed. When a source program, then the program is usually translated via a compiler (such as the compiler 74), assembler, interpreter, or the like, which may or may not be included within the memory 72, so as to operate properly in connection with the O/S 75. Furthermore, the application 76 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, JavaScript, FORTRAN, COBOL, Perl, Java, ADA, .NET, and the like.

The I/O devices 77 may include input devices such as, for example but not limited to, a mouse, keyboard, scanner, microphone, camera, etc. Furthermore, the I/O devices 77 may also include output devices, for example but not limited to a printer, display, etc. Finally, the I/O devices 77 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 77 also include components for communicating over various networks, such as the Internet or intranet.

If the processing system 70 is a PC, workstation, intelligent device or the like, the software in the memory 72 may further include a basic input output system (BIOS) (omitted for simplicity). The BIOS is a set of essential software routines that initialize and test hardware at startup, start the O/S 75, and support the transfer of data among the hardware devices. The BIOS is stored in some type of read-only-memory, such as ROM, PROM, EPROM, EEPROM or the like, so that the BIOS can be executed when the processing system 70 is activated.

When the processing system 70 is in operation, the processor 71 is configured to execute software stored within the memory 72, to communicate data to and from the memory 72, and to generally control operations of the processing system 70 pursuant to the software. The application 76 and the O/S 75 are read, in whole or in part, by the processor 71, perhaps buffered within the processor 71, and then executed.

When the application 76 is implemented in software it should be noted that the application 76 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 76 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The processing system readable medium can be, for example but not limited to, an electronic, magnetic, optical, electromagnetic, infrared, or semiconductor system, apparatus, device, or propagation medium.

The skilled person would be readily capable of developing a processing system for carrying out any herein described method. Thus, each step of the flow chart may represent a different action performed by a processing system, and may be performed by a respective module of the processing system.

Embodiments may therefore make use of a processing system. The processing system can be implemented in numerous ways, with software and/or hardware, to perform the various functions required. A processor is one example of a processing system which employs one or more microprocessors that may be programmed using software (e.g., microcode) to perform the required functions. A processing system may however be implemented with or without employing a processor, and also may be implemented as a combination of dedicated hardware to perform some functions and a processor (e.g., one or more programmed microprocessors and associated circuitry) to perform other functions.

Examples of processing system components that may be employed in various embodiments of the present disclosure include, but are not limited to, conventional microprocessors, application specific integrated circuits (ASICs), and field-programmable gate arrays (FPGAs).

In various implementations, a processor or processing system may be associated with one or more storage media such as volatile and non-volatile computer memory such as RAM, PROM, EPROM, and EEPROM. The storage media may be encoded with one or more programs that, when executed on one or more processors and/or processing systems, perform the required functions. Various storage media may be fixed within a processor or processing system or may be transportable, such that the one or more programs stored thereon can be loaded into a processor or processing system.

It will be understood that disclosed methods are preferably computer-implemented methods. As such, there is also proposed the concept of a computer program comprising code means for implementing any described method when said program is run on a processing system, such as a computer. Thus, different portions, lines or blocks of code of a computer program according to an embodiment may be executed by a processing system or computer to perform any herein described method. In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. Any reference signs in the claims should not be construed as limiting the scope.

1. A computer-implemented method of predicting a presence and/or position of a predetermined anatomical landmark with respect to a computed tomography medical image, the computer-implemented method comprising:
obtaining the image that contains a plurality of pixels or voxels;
processing the image using a machine-learning algorithm to generate, for each pixel or voxel of the image, an indicator representing a likelihood that the corresponding pixel or voxel represents part of a predetermined anatomical landmark; and
processing a plurality of the generated indicators to predict the presence and/or position of the predetermined anatomical landmark with respect to the image.

2. The computer-implemented method of claim 1, further comprising:
identifying, as high likelihood pixels/voxels, any pixels/voxels having a corresponding indicator that indicates a likelihood that the corresponding pixel or voxel of the image represents part of a predetermined anatomical landmark exceeds a predetermined threshold;
identifying the largest cluster of high likelihood pixels/voxels; and
predicting the position of the predetermined anatomical landmark to lie within the identified largest cluster of high likelihood pixels/voxels.

3. The computer-implemented method of claim 2, further comprising identifying a centroid of the identified largest cluster of high likelihood pixels/voxels as the position of the predetermined anatomical landmark.

4. The computer-implemented method of claim 2, further comprising:
performing a clustering algorithm on the high likelihood pixels/voxels to identify one or more clusters of high likelihood pixels/voxels; and
identifying the largest of the one or more clusters of high likelihood pixels/voxels.

5. The computer-implemented method of claim 4, wherein each cluster of high likelihood pixels/voxels comprises pixels that are adjacent to at least one other pixel in the cluster of high likelihood pixels/voxels.

6. The computer-implemented method of claim 1, wherein each indicator is a numeric indicator representing a probability that the corresponding pixel represents part of the predetermined anatomical landmark.

7. The computer-implemented method of claim 1, wherein each indicator is a binary indicator representing a prediction or whether the corresponding pixel represents part of the predetermined anatomical landmark.

8. The computer-implemented method of claim 1, wherein the predetermined anatomical landmark is an anatomical landmark defined by a predetermined set of guidelines for performing medical image scanning.

9. The computer-implemented method of claim 1, further comprising controlling a user interface to provide an output responsive to the predicted presence and/or position of the anatomical landmark with respect to the computer tomography image.

10-12. (canceled)

13. A processing system configured to predict a presence and/or position of a predetermined anatomical landmark with respect to a computed tomography medical image, the processing system comprising:
a memory that stores a plurality of instructions; and
a processor that couples to the memory and is configured to execute the plurality of instructions to:
obtain the image that contains a plurality of pixels or voxels;
process the image using a machine-learning algorithm to generate, for each pixel or voxel of the image, an indicator representing a likelihood that the corresponding pixel or voxel represents part of a predetermined anatomical landmark; and
process a plurality of the generated indicators to predict the presence and/or position of the predetermined anatomical landmark with respect to the medical image.

14. The processing system of claim 13, wherein the processor is configured to process the generated indicators by:
identifying, as high likelihood pixels/voxels, any pixels having a corresponding indicator that indicates a likelihood that the corresponding pixel or voxel of the image represents part of a predetermined anatomical landmark exceeds a predetermined threshold;
identifying the largest cluster of high likelihood pixels/voxels; and
predicting the position of the predetermined anatomical landmark to lie within the identified largest cluster of high likelihood pixels/voxels.

15. (canceled)

16. A non-transitory computer-readable medium for storing executable instructions, which cause a method to be performed for predicting a presence and/or position of a predetermined anatomical landmark with respect to a computed tomography medical image, the method comprising:
obtaining the image that contains a plurality of pixels or voxels;
processing the image using a machine-learning algorithm to generate, for each pixel or voxel of the image, an indicator representing a likelihood that the corresponding pixel or voxel represents part of a predetermined anatomical landmark; and
processing a plurality of the generated indicators to predict the presence and/or position of the predetermined anatomical landmark with respect to the image.
